(19) United States
(12) Patent Application Publication
(10) Pub. No.: US 2008/0277531 A1
(43) Pub. Date: Nov. 13, 2008

(54) Hybrid Composite Panel Systems and Methods

(75) Inventors: James F. Ackermann, Woodinville, WA (US); Gregory R. Gleason, Seattle, WA (US)

Correspondence Address: LEE & HAYES, PLLC, 421 W. RIVERSIDE AVE., SUITE 500, SPOKANE, WA, 99201, US

(73) Assignee: THE BOEING COMPANY, Chicago, IL (US)

(21) Appl. No.: 11/747,760

(22) Filed: May 11, 2007

(51) Int. Cl. B32B 7/00; B05D 1/00; B64C 1/00

(52) U.S. Cl. 244/133; 427/209; 428/98

(57) ABSTRACT

Hybrid composite panel systems and methods are disclosed. In one embodiment, an assembly includes a primary section, a matrix member engaged with the primary section, and a secondary section engaged with the matrix member opposite the primary section. The primary section includes a plurality of first composite layers reinforced with a first reinforcing material, and the secondary section includes a plurality of second composite layers reinforced with a second reinforcing material. The primary and secondary sections are configured to bear an operating load at least partially transversely to the first and second composite layers, and are asymetrically configured such that the primary section bears a majority of the applied operating load.

### FIELD OF THE INVENTION

The field of the present disclosure relates to composite panel systems and methods, and more specifically, to asymmetric composite panels formed using a hybrid process of automated and non-automated fabrication activities.

### BACKGROUND OF THE INVENTION

Due to the favorable strength and weight characteristics of composite materials, the use of composites in various industries continues to expand. In aircraft manufacturing, the increasing use of composite materials and composite structural assemblies is leading to significant reductions in aircraft weight. These weight savings translate to significant improvements in fuel economy, and substantial reduction of operating costs and atmospheric emissions. For example, due in large measure to the extensive use of composites, it has been estimated that Boeing's 787 “Dreamliner” aircraft will consume an estimated 20% less fuel than comparable contemporary aircraft.

The feasibility of using composite materials to form a structure depends on many factors, including the size and complexity of the structure and the loads the structure will experience. In the context of aircraft manufacturing, the wing skin panels present formidable challenges for the use of composites. The wing skin panels must be capable of carrying very high loads. Current methods use stringers attached to the skin panels to provide stiffness, but since extra wing depth increases aerodynamic drag, the size of the stringers must be kept to a minimum, particularly in the outermost portions of the wings. In addition, composite manufacturing processes that involve extensive hand-layup activities may result in undesirably high costs and slow production rates. Composite panel systems that meet the strength and size requirements imposed by aircraft wing skin panels, and that may be manufactured in an economical manner, would therefore have considerable utility.

### SUMMARY

Hybrid composite panel systems and methods in accordance with the teachings of the present disclosure may advantageously meet the strength and size requirements imposed by aircraft wing skin panels, and may result in reduced aircraft weight, reduced operating costs, improved fuel economy, and reduced emissions.

In one embodiment, an assembly includes a primary section, a matrix member engaged with the primary section, and a secondary section engaged with the matrix member opposite the primary section. The primary section includes a plurality of first composite layers reinforced with a first reinforcing material, and the secondary section includes a plurality of second composite layers reinforced with a second reinforcing material. The primary and secondary sections are configured to bear an operating load at least partially transversely to the first and second composite layers, and are asymetrically configured such that the primary section bears a majority of the applied operating load.

In another embodiment, a vehicle includes at least one propulsion unit, and a structural assembly coupled to the at least one propulsion unit and configured to support a payload. The structural assembly includes at least one composite panel that includes a primary section, a matrix member engaged with the primary section, and a secondary section engaged with the matrix member opposite the primary section. As noted above, the primary section includes a plurality of first composite layers reinforced with a first reinforcing material, and the secondary section includes a plurality of second composite layers reinforced with a second reinforcing material. The primary and secondary sections are configured to bear an operating load at least partially transversely to the first and second composite layers, and are asymetrically configured such that the primary section bears a majority of the applied operating load.

In a further embodiment, a method of forming a composite structure includes forming a primary section including a plurality of first composite layers reinforced with a first reinforcing material; engaging a matrix member with the primary section; and forming a secondary section including a plurality of second composite layers reinforced with a second reinforcing material. The secondary section is engaged with the matrix member opposite from the primary section, wherein the primary and secondary sections are configured to bear an operating load at least partially transversely to the first and second composite layers, and the primary and secondary sections being asymetrically configured such that the primary section bears a majority of the applied operating load.

The features, functions, and advantages that have been above or will be discussed below can be achieved independently in various embodiments, or may be combined in yet other embodiments, further details of which can be seen with reference to the following description and drawings.

### BRIEF DESCRIPTION OF THE DRAWINGS

Embodiments of systems and methods in accordance with the teachings of the present disclosure are described in detail below with reference to the following drawings.

FIG. 1 is an isometric view of an aircraft that includes a hybrid composite panel in accordance with an embodiment of the invention;

FIG. 2 is an enlarged, sectional plan view of a wingtip portion of a assembly of FIG. 1;

FIG. 3 is a partially-exploded, end cross-sectional view of the hybrid composite panel of the wing assembly of FIG. 1; and

FIG. 4 is a flow chart of an exemplary process for manufacturing a hybrid composite panel in accordance with another embodiment of the invention.

### DETAILED DESCRIPTION

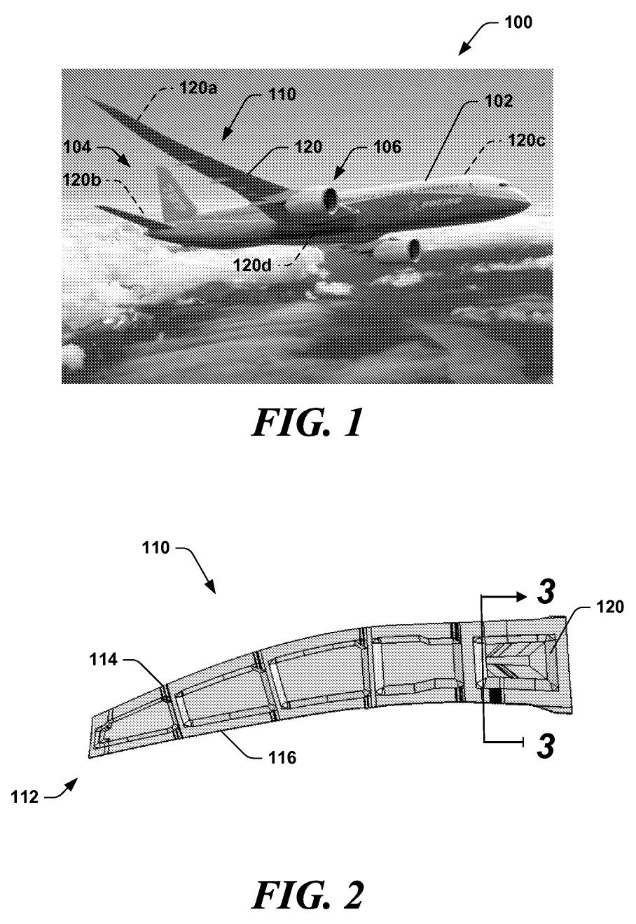

The present disclosure teaches hybrid composite panel systems and methods. Many specific details of certain embodiments of the invention are set forth in the following description and in FIGS. 1-4 to provide a thorough understanding of such embodiments. One skilled in the art will understand, however, that the invention may have additional embodiments, or that the invention may be practiced without several of the details described in the following description.

In general, embodiments of hybrid composite panel systems and methods in accordance with the teachings of the present disclosure include relatively thick, load-carrying outer plies, a honeycomb core, and one or more inner fabric plies. The outer plies may include high-strength, high modulus, toughened epoxy uni-directional composite tape that is applied using one or more automated machines. The bulk of the load-carrying material resides in these outer tape plies. The honeycomb core may be positioned on the outer, load-carrying plies and then covered with a limited number of inner fabric plies that can be laid down by hand. Thus, hybrid composite panel systems and methods in accordance with the present disclosure combine the stiffer, higher strength and more durable uni-directional composite tape layers that are formed using automated processes with the less expensive, lower strength inner fabric plies that may be laid down by hand to provide a carbon composite material system having desirable stiffness, strength, weight, durability and manufacturability characteristics.

FIG. 1 is an isometric view of an aircraft 100 in accordance with an embodiment of the invention. In this embodiment, the aircraft 100 includes a fuselage 102 having an interior region configured to carry passengers and cargo. A pair of wing assemblies 110 project laterally outwardly from a mid-section of the fuselage 102. Each wing assembly 110 includes a hybrid composite panel 120 in accordance with the teachings of the present disclosure, as described more fully below. A tail assembly 104 is coupled to an aft portion of the fuselage 102, and a propulsion unit 106 is coupled to each of the wing assemblies 110. The aircraft 100 also includes a variety of components and systems that are generally known in the art, and that cooperatively provide the desired capabilities for proper operation of the aircraft 100, which, for the sake of brevity, will not be described in detail herein.

FIG. 2 is an enlarged, sectional plan view of one of the wing assemblies 110 (i.e. the left side wing assembly 110) of the aircraft 100 of FIG. 1. More specifically, in FIG. 2, an upper portion of the wing assembly 110 has been removed, exposing a lower portion of the wing assembly 110 that includes the hybrid composite panel 120. For reference, the wing assembly 110 has a wingtip portion 112, a leading edge 114, and a trailing edge 116. It will be appreciated that the wing assembly 110 may include a plurality of hybrid composite panels 120, and that the upper portion that has been removed for illustrative purposes from FIG. 2 may also include one or more hybrid composite panels 120.

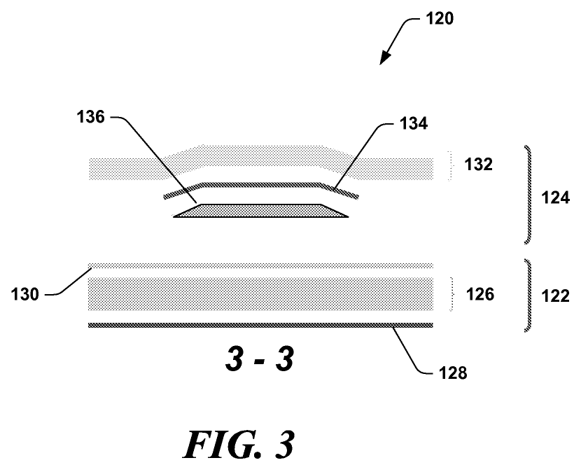

FIG. 3 is a partially-exploded, end cross-sectional view of the hybrid composite panel 120 of the wing assembly 110 as viewed along line 3-3 of FIG. 2. In this embodiment, the hybrid composite panel 120 is asymmetrically configured and includes a high-strength, impact resistant portion 122 and a low-strength portion 124. The high-strength, impact resistant portion 122 is configured to bear a majority of the loads applied to the hybrid composite panel 120, and the low-strength portion 124 is configured to bear substantially less of the applied loads. For example, in some embodiments, the high-strength portion 122 is configured to bear at least 70% of the applied load to the hybrid composite panel 120 during normal operating conditions. In other embodiments, the high-strength portion 122 is configured to bear over 90% of the applied loads.

As further shown in FIG. 3, the high-strength, impact resistant portion 122 includes a primary section 126 that is formed from a plurality of fiber-reinforced composite layers. The primary section 126 is the main load-bearing section of the high-strength portion 122. In some embodiments, the primary section 126 is formed using automated composite layer application devices. An outer layer 128 is formed on an outwardly-facing surface of the primary section 126, providing a relatively-smooth, relatively-durable protective surface that helps protect the primary section 126 from possible physical damage and degradation due to the elements. A bonding layer 130 (e.g. adhesive) is formed on an inwardly-facing surface of the primary section 126.

The low-strength portion 124 includes a secondary section 132 formed from a plurality of fabric-reinforced composite layers. In some embodiments, the layers of the secondary section 132 are formed using manual or “hand-layup” processes. A second bonding layer 134 is coupled between a stiffener section 136 and the secondary section 132. The stiffener section 136 provides stiffness to the hybrid composite panel 120. In some embodiments, the stiffener section 136 is formed of a lightweight matrix material having a plurality of open-space cells defined by intersecting thin walls of a relatively-rigid material. More specifically, in particular embodiments, the stiffener section 136 is formed of a matrix material (e.g. aluminum, titanium, non metallic resin impregnated material, Al and Ti alloys, other metals or non-metals, etc.) having polygonal or “honeycomb”-shaped cells. The low-strength portion 124 is coupled to the bonding layer 130 of the high-strength portion 122.

It may be appreciated that specific design details of the hybrid composite panel 120 (e.g. dimensions, materials, thermo-mechanical properties, etc.) may be variably adjusted to satisfy a wide variety of requirements and operating conditions. For example, in some embodiments, the primary section 126 is formed from successive layers of a fiber-reinforced, composite tape material having unidirectional fibers that are generally aligned along one axis (e.g. the principal stress direction). In alternate embodiments, however, the reinforcing fibers of the primary section 126 may be multi-directionally oriented.

In particular embodiments, the thick, durable load carrying outer plies of the primary section 126 are toughened epoxy uni-directional tape that is laid on a tool surface by automated machines. The bulk of the load carrying material may reside in these outer tape plies. Automated systems for forming composite structures using successive layers of fiber-reinforced composite tape include those systems disclosed, for example, in U.S. Pat. No. 6,799,619 B2 issued to Holmes et al., and U.S. Pat. No. 6,871,684 B2 issued to Engelbart et al. A honeycomb core may be laid over these plies and then covered with a limited number of inner fabric-reinforced plies that can be laid down by hand. This configuration combines the higher strength and stiffness uni-directional tape that is built using automation with the less expensive lower strength and stiffness inner fabric plies laid down by hand.

The reinforcing fibers may be formed using a variety of materials, including fibers containing metals, alloys, polymers, ceramics, naturally-occurring materials, synthetic materials, or any other suitable materials. A range of thermo-setting and thermo-plastic fiber-reinforced composite tape materials are generally known. For example, suitable fiber-reinforced composite tape materials that may be used in the high-strength portion 122 include those materials commercially available from Specialty Materials, Inc. of Lowell, Mass., and those materials developed by (or on behalf of) the NASA Langley Research Center of Langley, Va., and the NASA Goddard Space Flight Center of Greenbelt, Md., or any other suitable fiber-reinforced composite materials. Similarly, the fabric-reinforced composite materials used in the low-strength portion 124 may include those materials commercially available from Argosy International, Inc. of New York, N.Y., or those materials developed by (or on behalf of) the NASA Glenn Research Center of Cleveland, Ohio, or any other suitable fabric-reinforced composite materials.

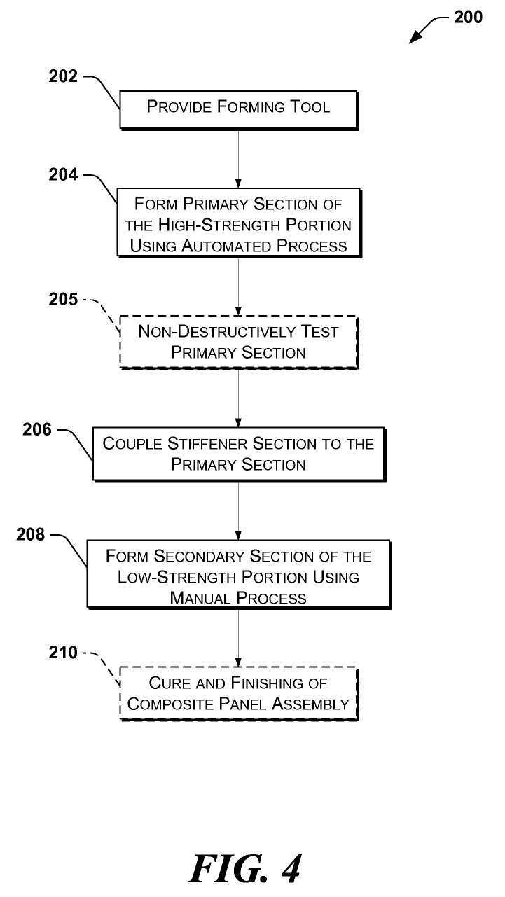

Hybrid composite panels in accordance with the teachings of the present disclosure may be fabricated in a variety of ways. For example, FIG. 4 is a flow chart of an exemplary process 200 for manufacturing a hybrid composite panel in accordance with another embodiment of the invention. For discussion purposes, the exemplary process 200 is described below with reference to the exemplary components described above with reference to FIGS. 1 through 3.

In this embodiment, the process 200 includes providing a suitable forming tool (or mandrel) upon which a hybrid composite panel will be partially or completely formed at 202. For example, in some embodiments, the forming tool may be shaped to form an aircraft component (e.g. a wing skin panel). At 204, the primary section 126 of the high-strength portion 122 is formed on the forming tool using an automated process. The forming of the primary section 126 at 204 may include both application and curing of the successive fiber-reinforced composite layers. Alternately, the forming at 204 may include application of the fiber-reinforced composite layers, and curing of the fiber-reinforced composite layers may occur at another portion of the process 200.

In addition, in some embodiments, the primary section 126 may be formed at 204 using automated systems for application and consolidation (e.g. positioning, compaction, curing, etc.) of fiber-reinforced composite tape materials. The reinforcing fibers within the composite layers of the primary section 126 may be unidirectional (e.g. extending along a longitudinal axis of the wing assembly 110), or alternately, may be multi-directionally oriented. As previously noted, the primary section 126 is configured to carry a majority of the applied loads experienced by the hybrid composite panel during normal operating conditions. At an optional block 205, assuming the primary section 126 has been cured during the forming at 204, the primary section 126 may be non-destructively tested for any desired characteristics (e.g. strength, porosity, flaws, etc.).

As further shown in FIG. 4, the stiffener section 136 is coupled to the primary section 126 at 206. In some embodiments, the stiffener section 136 is coupled to the primary section 126 via a bonding layer 130 (FIG. 3), which may be formed of a suitable adhesive. Alternately, any other suitable technique may be used for coupling the stiffener section 136 to the primary section 126, including the use of one or more intermediate layers.

The secondary section 132 of the low-strength portion 124 is formed on the stiffener section 136 using a manual application process at 208. More specifically, in some embodiments, the secondary section 132 may be formed by applying successive layers of fabric-reinforced composite materials using manual or “hand-layup” processes. The forming of the secondary section 132 (at 208) may include both application and curing of the successive fabric-reinforced composite layers, or alternately, the curing of the fabric-reinforced composite layers may occur at another portion of the process 200.

At an optional block 210, one or more portions of the hybrid composite panel assembly may be cured and finished. For example, the curing at 210 may include curing (e.g. using an elevated temperature, an elevated pressure, or both) the primary section 126, the secondary section 132, or both. In particular embodiments, the primary section 126 is cured during the forming at 204, while the secondary section 132 is cured at 210 by placing the hybrid composite panel assembly into an autoclave and using a curing process involving the controlled application of elevated temperatures and/or pressures. The finishing at 210 may also include forming the protective outer layer 128 on the primary section 126, or any other desired shaping, machining, or conditioning operations.

It should be appreciated that the exemplary process 200 is one possible embodiment, and that a variety of processes in accordance with the present disclosure may be conceived. For example, in an alternate embodiment, a process for forming a composite panel assembly may include forming a high-strength build up of composite plies, curing the high-strength build up at a first elevated temperature and pressure, and non-destructively testing the high-strength build up for porosity or other characteristics. After testing, the process includes applying a stiffening matrix member to the high-strength build up, forming a low-strength build up of composite plies over the stiffening matrix member, and then curing the assembly at a second temperature and/or pressure less than the first elevated temperature and/or pressure. This alternate process advantageously allows the high-strength build up to be thoroughly inspected (e.g. for porosity) in a manner that may not be practical or possible after the high-strength build up is coupled to the stiffener and low-strength build up.

Embodiments of fabrication processes (e.g. process 200) in accordance with the present disclosure may be used to fabricate a variety of components. For example, in alternate embodiments, hybrid composite panels in accordance with the present disclosure may be used in various portions of an aircraft. More specifically, as shown in FIG. 1, embodiments of hybrid composite panels may be used in the tail assembly 104 (e.g. panel 120b), the fuselage 102 (e.g. panel 120c), the propulsion units 106 (e.g. panel 120d), or any other suitable portions of the aircraft 100.

Although the aircraft 100 shown in FIG. 1 is generally representative of a commercial passenger aircraft, such as the 787 “Dreamliner” aircraft available from The Boeing Company of Chicago, Ill., it will be appreciated that in alternate embodiments, any other type of aircraft may be equipped with embodiments of hybrid composite panel systems in accordance with the present disclosure. For example, in alternate embodiments, systems and methods in accordance with the present disclosure may be incorporated in other types of aerospace vehicles, including military aircraft, rotary wing aircraft, unmanned aerial vehicles, missiles, rockets, and any other suitable types of vehicles and platforms, as illustrated more fully in various reference texts, such as Jane's All The World's Aircraft available from Jane's Information Group, Ltd. of Coulsdon, Surrey, UK. In still other embodiments, hybrid composite panels in accordance with the present disclosure may be used in the construction of watercraft, automobiles, building components, containers, and any other structures and assemblies.

Embodiments of hybrid composite panel systems and methods in accordance with the teachings of the present disclosure may provide significant advantages. For example, such hybrid composite panel systems and methods may advantageously meet the strength, weight, and size requirements imposed by demanding operating environments, such as aircraft wing skin panels and other high-load, highly-constrained environments. More specifically, embodiments of hybrid composite panels allow for thin wing development while meeting the high load carrying requirements. Thin wing development increases wing performance, resulting in reduced aircraft operating costs, improved fuel economy, and reduced emissions.

Furthermore, hybrid composite panels in accordance with the present disclosure allow the outer plies (e.g. the high-strength portion 122) to carry the bulk of the wing load. The outer ply manufacturing allows automated machines to do most of the fabrication, reducing labor hours and overall manufacturing costs. Furthermore, uni-directional tape is typically much cheaper than the comparable fabric material of similar strength, providing additional cost reduction. As noted above, in some embodiments, the outer plies may be cured and processed to a higher strength specification by curing prior to the addition of the stiffener section and the inner, fabric-reinforced layers of the secondary section. By adding the stiffener section and inner fabric layers (e.g. the low-strength portion 124) after the outer tape layers are applied, the hybrid composite panel assembly may be processed to a lower manufacturing specification which allows the use of less expensive inner fabric material and limits the number of plies needed. This advantageously reduces the amount of hand fabrication time and reduces labor costs.

It will be appreciated that the method of application of composite plies in a build up or finished product may be determined through inspection. Typically, components created using automated build up processes exhibit greater uniformity than do components formed using manual build up processes. In some embodiments, automated processes may also leave readily discernable characteristics and features (e.g. cyclic or repetitive features) within the build up that can be detected by inspection, and which may be used to ascertain the manner in which the build up was formed.

While specific embodiments of the invention have been illustrated and described herein, as noted above, many changes can be made without departing from the spirit and scope of the invention. Accordingly, the scope of the invention should not be limited by the disclosure of the specific embodiments set forth above. Instead, the invention should be determined entirely by reference to the claims that follow.

What is claimed is:

1. An assembly, comprising:
a primary section including a plurality of first composite layers reinforced with a first reinforcing material;
a matrix member engaged with the primary section; and
a secondary section including a plurality of second composite layers reinforced with a second reinforcing material, the secondary section being engaged with the matrix member opposite from the primary section, wherein the primary and secondary sections are configured to bear an operating load at least partially transversely to the first and second composite layers, and the primary and secondary sections being further asymetrically configured such that the primary section bears a majority of the applied operating load.

2. The assembly of claim 1, wherein the first reinforcing material comprises a plurality of reinforcing fibers and the second reinforcing material comprises a reinforcing fabric.

3. The assembly of claim 2, wherein the plurality of reinforcing fibers comprises a plurality of unidirectional fibers.

4. The assembly of claim 1, wherein the plurality of first composite layers of the primary section is formed using an automated application process, and the plurality of second composite layers of the secondary section is formed using a manual application process.

5. The assembly of claim 4, wherein the automated application process includes an automated composite tape application process.

6. The assembly of claim 1, wherein the matrix member comprises a plurality of intersecting walls oriented approximately transversely to the plurality of first composite layers, the intersecting walls being formed of an approximately rigid material and defining a plurality of open-space cells.

7. The assembly of claim 6, wherein the plurality of open-space cells include a plurality of polygonal cells.

8. A vehicle, comprising:
at least one propulsion unit;
a structural assembly coupled to the at least one propulsion unit and configured to support a payload, the structural assembly including at least one composite panel having:
a primary section including a plurality of first composite layers reinforced with a first reinforcing material;
a matrix member engaged with the primary section; and
a secondary section including a plurality of second composite layers reinforced with a second reinforcing material, the secondary section being engaged with the matrix member opposite from the primary section, wherein the primary and secondary sections are configured to bear an operating load applied at least partially transversely to the first and second composite layers, and the primary and secondary sections being further asymetrically configured such that the primary section bears a majority of the applied operating load.

9. The vehicle of claim 8, wherein the first reinforcing material comprises a plurality of reinforcing fibers and the second reinforcing material comprises a reinforcing fabric.

10. The vehicle of claim 8, wherein the plurality of first composite layers of the primary section is formed using an automated application process, and the plurality of second composite layers of the secondary section is formed using a manual application process.

11. The vehicle of claim 8, wherein the at least one propulsion unit comprises an aircraft engine.

12. The vehicle of claim 11, wherein the structural assembly includes an elongated fuselage having an interior region configured to receive the payload, a pair of wing assemblies projecting outwardly from the fuselage and configured to provide aerodynamic lift, and a tail assembly coupled to an end portion of the fuselage, and wherein the at least one composite panel is disposed within at least one of the fuselage, the wing assemblies, and the tail assembly.

13. A method of forming a composite structure, comprising:
forming a primary section including a plurality of first composite layers reinforced with a first reinforcing material;
engaging a matrix member with the primary section; and
forming a secondary section including a plurality of second composite layers reinforced with a second reinforcing material, the secondary section being engaged with the matrix member opposite from the primary section, wherein the primary and secondary sections are configured to bear an operating load at least partially transversely to the first and second composite layers, and the primary and secondary sections being further asymetrically configured such that the primary section bears a majority of the applied operating load.

14. The method of claim 13, wherein forming a primary section first includes forming a primary section including a plurality of first composite layers reinforced with a plurality of reinforcing fibers, and wherein forming a secondary section includes forming a secondary section including a plurality of second composite layers reinforced with a reinforcing fabric.

15. The method of claim 13, wherein forming a primary section first includes forming a primary section using an automated application process, and wherein forming a secondary section includes forming a secondary section using a manual application process.

16. The method of claim 15, wherein the automated application process includes an automated composite tape application process.

17. The method of claim 13, wherein engaging a matrix member with the primary section includes engaging a matrix member having a plurality of intersecting walls oriented approximately transversely to the plurality of first composite layers, the intersecting walls being formed of an approximately rigid material and defining a plurality of open-space cells.

18. The method of claim 13, wherein forming the primary section includes curing the primary section prior to engaging the matrix member with the primary section.

19. The method of claim 18, wherein curing the primary section includes curing the primary section at a first elevated temperature and pressure, the method further comprising curing the secondary section at a second elevated temperature and pressure after engaging the matrix member with the primary section and after forming the secondary section, the second elevated temperature and/or pressure being lower than the first elevated temperature.

20. The method of claim 13, wherein at least one of forming the primary section and forming the secondary section includes curing a corresponding one the primary and secondary sections.
